(19) United States
(12) Patent Application Publication
(10) Pub. No.: US 2012/0279031 A1
(43) Pub. Date: Nov. 8, 2012

(54) PRODUCTION LINE FOR HIGH TEMPERATURE ALLOY FURNACE PIPES AND PIPEROWS USED IN PETROCHEMICAL INDUSTRY

(76) Inventors: Jie Pu, Jinjiang City (CN); Mingsheng He, Jinjiang City (CN)

(21) Appl. No.: 13/300,768

(22) Filed: Nov. 21, 2011

(30) Foreign Application Priority Data
May 6, 2011 (CN) 201110116796.3

(51) Int. Cl. B23P 23/04

(52) U.S. Cl. 29/33.5

(57) ABSTRACT

A production line for manufacturing high temperature alloy furnace pipes and piperows characterized in that it comprises of a casting department production line, a machining department production line and a welding department production line. In the casting production line, a pipeline section is casted via the process of centrifugal casting. In the machining process, the tectorium of internal bore of the pipeline section is removed via the process of boring hole and a groove is machined via a digitally controlled pipe machine. In the welding process, the pipeline sections are welded into a long pipe via the process of argon-arc welding, and flanges and pipe fittings are welded to make a furnace pipes, and further, long furnace pipes are welded into piperows. Finally, quality products of furnace pipes and piperows are ensured through a series of testing equipments and testing procedures.

### CLAIM OF PRIORITY

The present application claims the benefit of Chinese Application No. 2011-10116796.3, filed on May 6, 2011, which is incorporated herein by reference in its entirety.

### TECHNICAL FIELD

The present invention relates to a production line for high temperature alloy furnace pipes and piperows used in petrochemical industry, including all equipments used in casting, machining, welding, and packaging process, and equipments used for testing and for scientific arrangement of monitoring points that are all connected via tracks into a production line to ensure an effective movement of processed pipes and piperows and quality end product through the production and inspection procedure.

### BACKGROUND OF THE INVENTION

Furnace pipes and piperows for petrochemical industry are mainly used for the ethylene cracking furnace and the hydrogen reformer.

An ethylene cracking furnace is the most important equipment for producing raw ethylene gas from the oil gas. Ethylene product is an important raw chemical product in daily life. The development level of ethylene product is an important indicator of the development level of a country's petrochemical industry.

The hydrogen reformer is used for producing hydrogen with the oil gas, which can be synthesized for ammonia to make chemical fertilizer used in agriculture, or can be synthesized for methanol to partially substitute gasoline, or can be used as the basic raw material of the dimethyl ether, acetic acid and other chemical products, or can be used as the raw material of the iron reduction reaction in the metallurgical industry, or can especially be used for the hydrogenation in the oil refining industry by the way of hydro-cracking for refining more and better gasoline from heavy wax oil to improve fuel quality to meet environmental needs.

With the development of research of hydrogen-powered clean energy, the number of hydrogen stations will be as many as the gas stations as we see today. More hydrogen reformers will be needed to produce enough hydrogen.

High temperature alloy furnace pipes and piperows used in petrochemical industry is required to work continuously in an environment filled with corrosive media, usually in 800-1200° C. temperature, 2.0-4.0 MPa pressure. Its designed life is about 100,000 hours (approximately 11 years) due to harsh environment.

Presently, the manufacturers of high temperature alloy furnace pipes and piperows used in petrochemical industry is classified into three groups:

Group 1: Small-scale manufacturers who are not specialized manufacturers of high temperature alloy furnace pipes and piperows used in petrochemical industry. These manufacturers produce furnace pipes and piperows together with other similar products. Thus it will easily result in disqualified furnace pipes and piperows because of the differences in production requirements, production processes and testing procedures and requirements between furnace pipes and piperows and other similar products.

Group 2: Small-scale and specialized manufacturers of high temperature alloy furnace pipes and piperows used in petrochemical industry. However, their production and testing equipments are outdated and incomplete, and their arrangement of production processes and testing procedures is unscientific. Their product quality is unstable and unreliable.

Group 3: Big-scale and specialized manufacturers of high temperature alloy furnace pipes and piperows used in petrochemical industry with complete production and testing equipments. However their arrangement of production processes and testing procedures is unscientific. Their production processes and testing procedures depend on the driving mechanism that results in disorganization. Their product quality is still unstable.

### SUMMARY OF THE INVENTION

The object of the present invention is to provide a production line for manufacturing high temperature alloy furnace pipes and piperows used in petrochemical industry that have overcome the above-mentioned shortcomings. The object of the invention is achieved by providing a production line for manufacturing high temperature alloy furnace pipes and piperows characterized in that: comprising a casting department production line, a machining department production line and a welding department production line. In the casting production line, a pipeline section is casted into 50-300 mm diameter and 3-6 m length via the process of centrifugal casting. In the machining process, the tectorium of internal bore of the pipeline section is removed via the process of boring hole and a groove is machined via a digitally controlled pipe machine. In the welding process, the pipeline sections are welded into a long pipe via the process of argon-arc welding, and flanges and pipe fitting are welded to make a furnace pipes, and further, long furnace pipes are welded into piperows. Finally, quality products of furnace pipes and piperows are ensured through a series of testing equipments and testing procedures that include a chemical composition test, a mechanical performance test at a room temperature, a mechanical performance test at a high temperature, an air pressure test, a hydraulic pressure test, a fluorescent crack detection, a dye penetrant inspection, a x-ray penetrant inspection, a visual inspection and a dimensional inspection.

The said casting department production line of the invention arranges a centrifuge in the middle and an intermediate frequency induction furnace at the top right side; the said right side of said intermediate frequency induction furnace is equipped with a heat treatment zone and its bottom left side is equipped with a shaped pipe storage area and its bottom right side is equipped with a sand mold casting area; a pneumatic pipe-pulling car and the pneumatic pipe-pulling car track, leading to a rough pipe storage area above, are equipped above the said centrifuge. Started from the rough pipe storage area, a rough furnace pipe is conveyed around the centrifuge and counterclockwise in turn by a conveyor roller through a shot blast machine, a rough pipe inspection area, a ready-to-cut area, a pipe cutting area, a fluorescent and gas-tight inspection device area and a fluorescent compartment, and is conveyed to the machining department production line through a safety passage. The said casting department production line of the invention arranges a centrifuge in the middle and an intermediate frequency induction furnace at the top right side; the said right side of said intermediate frequency induction furnace is equipped with a heat treatment zone and its bottom left side is equipped with a shaped pipe storage area and its bottom right side is equipped with a sand mold casting area; a pneumatic drawbench car and the pneumatic drawbench car track, leading to a rough pipe storage area above, are equipped with the above said centrifuge. Started from the rough pipe storage area, a rough furnace pipe is conveyed around the centrifuge and counterclockwise in turn by a conveyor roller through a shot blast machine, a rough pipe inspection area, a ready-to-cut area, a pipe cutting area, a fluorescent and gas-tight inspection device area and a fluorescent compartment, and is conveyed to the machining department production line through a safety passage.

The said machining department production line of the invention arranges a boring area of deep hole boring machine of the furnace pipes at the right side divided into two rows up and down, the top right side is equipped with a rough pipe storage area; its left side is also divided into two rows up and down, left of the bottom left side is equipped with a hydraulic pipe section pressure area, right of the bottom left side is equipped with an area for dimensional inspection, roughness inspection and turbulence experiment; its top left side is equipped with an pipe distributing area, cutting area, chambering preparing area, digitally-controlled groove machining area, dimensional inspection and groove dye penetrant area in turn from right to left. Conveyor rollers are arranged among the above processes and convey semi-finished furnace pipes through a safety passage into the welding department production line.

The said welding department production line of the invention arranges auto-welding area, auto-welding dye penetrant area, manual argon-arc welding area, straightening area, dye area, weld root polishing area and X-ray transferring area in turn from right to left in the first row and arranges X-ray area, manual argon-arc welding area, straightening and long pipe dye area, hydraulic pressure test area, furnace pipe products boring area, processed furnace pipes inspecting and packaging area, and processed products consignment area in turn from left to right in the second row; furnace pipe transferring area is arranged in the packaging and inspecting area for processed furnace pipes; piperow transferring device, piperow welding area, piperow dye area, piperow hydraulic pressure test area are arranged below the said furnace pipe transferring area in turn from right to left in the third row, and piperow shot blasting room, piperow package area, piperow consignment area are arranged in turn from left to right in the fourth row, and conveyor rollers are arranged among the above processes.

All equipments of all processes are connected compactly and occupy economical working space. Furnace pipes flows through each testing procedure and testing equipment. Therefore, quality control of production is organized to ensure every product is inspected. Furnace pipes are carried by conveyer rollers and overhead crane is not required to ensure furnace pipes and working staff on the ground are not hurt. Noise is reduced as well. Stable and reliable product quality is ensured and production and economic efficiency is enhanced while labor intensity is reduced.

### BRIEF DESCRIPTION OF THE DRAWINGS

FIG. 1 illustrates a flowchart of the casting department production line of the invention;

FIG. 2 illustrates a flowchart of the machining department production line of the invention;

FIG. 3 illustrates a flowchart of the welding department production line of the invention.

### DETAILED DESCRIPTION OF THE INVENTION

A production line for manufacturing high temperature alloy furnace pipes and piperows used in petrochemical industry comprises of a casting department production line, a machining department production line and a welding department production line. In the casting production line, a pipeline section is casted into 50-300 mm diameter and 3-6 m length via the process of centrifugal casting. In the machining process, the tectorium of internal bore of the pipeline section is removed via the process of boring hole and a groove is machined via a digitally controlled pipe machine. In the welding process, the pipeline sections are welded into a long pipe via the process of argon-arc welding, and flanges and pipe fitting are welded to make a furnace pipes, and further, long furnace pipes are welded into piperows. Finally, quality products of furnace pipes and piperows are ensured through a series of testing equipments and testing procedures that include a chemical composition test, a mechanical performance test at a room temperature, a mechanical performance test at a high temperature, an air pressure test, a hydraulic pressure test, a fluorescent crack detection, a dye penetrant inspection, a x-ray penetrant inspection, a visual inspection and a dimensional inspection. The said casting department production line of the invention arranges a centrifuge in the middle and an intermediate frequency induction furnace at the top right side; the right side of said intermediate frequency induction furnace is equipped with a heat treatment zone, its bottom left side is equipped with a shaped tube storage area and its bottom right side is equipped with a sand mold casting area; a pneumatic drawbench car and the pneumatic drawbench car track, leading to a rough pipe storage area above, are equipped with the above said centrifuge. Started from the rough pipe storage area, a rough furnace pipe is conveyed around the centrifuge and counterclockwise in turn by a conveyor roller through a shot blast machine, a rough pipe inspection area, a ready-to-cut area, a pipe cutting area, a fluorescent and gas-tight inspection device area and a fluorescent compartment, and is conveyed to the machining department production line through a safety passage. The said machining department production line of the invention arranges a boring area of deep hole boring machine of the furnace pipes at the right side divided into two rows up and down, the top right side is equipped with a rough pipe storage area; its left side is also divided into two rows up and down, left of the bottom left side is equipped with a hydraulic pipe section pressure area, right of the bottom left side is equipped with an area for dimensional inspection, roughness inspection and turbulence experiment; its top left side is equipped with an pipe distributing area, cutting area, chambering preparing area, digitally-controlled groove machining area, dimensional inspection and groove dye penetrant area in turn from right to left. Conveyor rollers are arranged among the above processes and convey semi-finished furnace pipes through a safety passage into the welding department production line. The said welding department production line of the invention arranges auto-welding area, auto-welding dye penetrant area, manual argon-arc welding area, straightening area, dye area, weld root polishing area and X-ray transferring area in turn from right to left in the first row and arranges X-ray area, manual argon-arc welding area, straightening and long pipe dye area, hydraulic pressure test area, furnace pipe products boring area, processed furnace pipes inspecting and packaging area, and processed products consignment area in turn from left to right in the second row; furnace pipe transferring area is arranged in the packaging and inspecting area for processed furnace pipes; piperow transferring device, piperow welding area, piperow dye area, piperow hydraulic pressure test area are arranged below the said furnace pipe transferring area in turn from right to left in the third row, and piperow shot blasting room, piperow package area, piperow consignment area are arranged in turn from left to right in the fourth row, and conveyor rollers are arranged among the above processes.

### Preferred Embodiment

In particular, a production line for manufacturing furnace pipes and piperows comprises of a casting department production line that produces and tests rough pipe sections, a machining department production line that produces and tests semi-processed pipe sections and a welding department production line that produces and tests processed pipes and piperows.

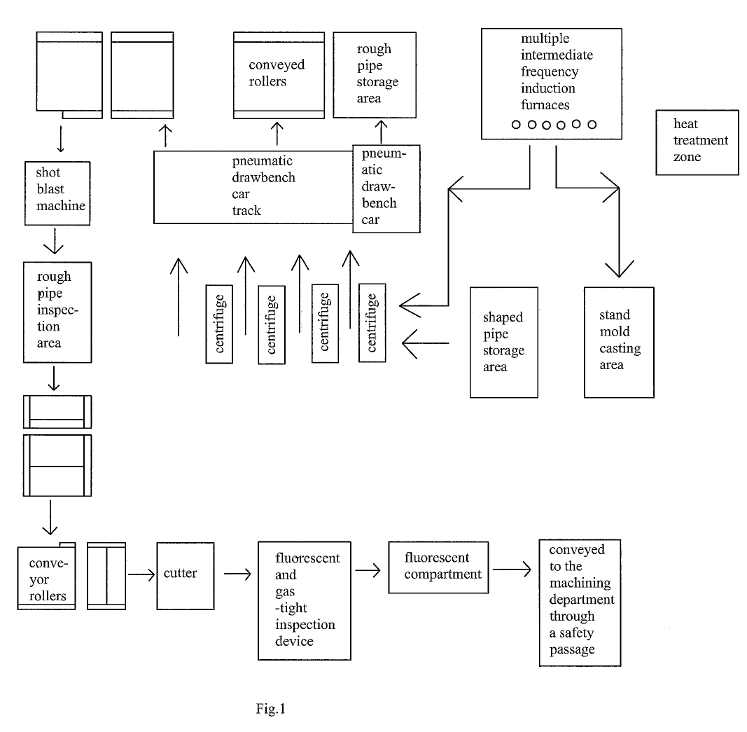

As illustrated in FIG. 1, the casting department production line of the present invention arranges centrifuge in the centre, intermediate frequency induction furnace at the top right and all centrifugal casting equipments, relative testing equipment and testing points are arranged in the shape of U. Qualified molten steel is poured into centrifuge that is spinning at high speed in accordance with technical requirements and is centrifugal casted into furnace pipe sections. The pipe sections are then conveyed to rough pipe storage area by pneumatic drawbench car, and further conveyed to shot blast machine for blasting by conveyor rollers. The blasted pipe sections are conveyed by rollers to rough furnace pipe testing area to test mechanical performance and mark out metallographic specimen. Tested rough pipes are conveyed by rollers to cutting area to cut both ends. The rough pipes are further conveyed to fluorescent and gas-tight inspection area to be tested before they are accepted as qualified rough pipe sections.

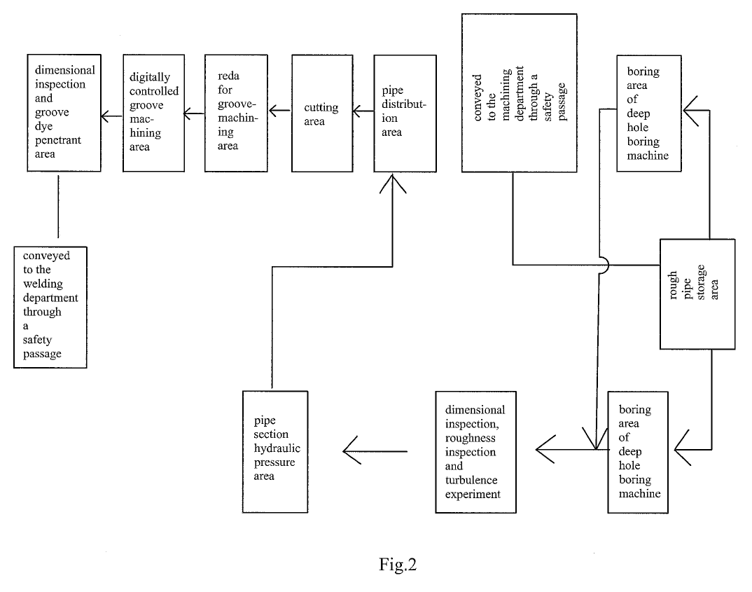

As illustrated in FIG. 2, the said machining department production line of the invention arranges a boring area of deep hole boring machine at the right side divided into two rows up and down where the qualified furnace pipe sections conveyed from the casting department are bored and the tectorium of internal bore of the pipeline sections is removed. After passing dimensional inspection, roughness inspection, turbulence experiment and hydraulic pressure test, the pipe sections are conveyed by rollers to pipe distributing area to carry out the arrangement of long furnace pipes in order to determine the length of pipe sections. Length cutting of pipe is carried out in cutting area. The pipe sections are then processed by digitally controlled groove machining area. After passing dimensional inspection and dying test, they are accepted as qualified semi-processed products.

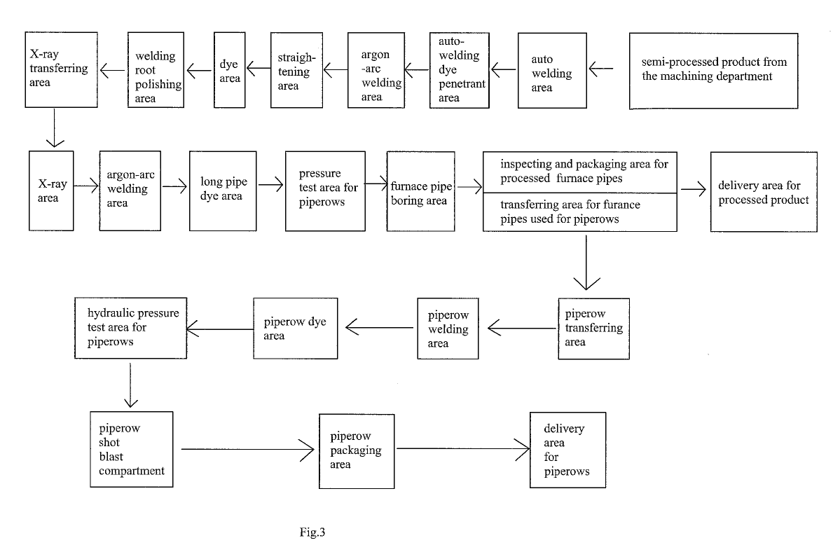

As illustrated in FIG. 3, 1). Product delivered as long furnace pipes. The furnace pipes are conveyed into the welding department where auto welding areas are arranged in the first row from right to left. Auto welding machines carry out root welding at the welding line between matched and qualified furnace pipe sections to long pipes specified by the drawing. The pipes are then conveyed by rollers to auto welding dye area to carry out dye test, further to manual argon-arc welding to fill seams of welding lines of long furnace pipes. The pipes are then conveyed to straightening area, dye area and polishing area to carry out straightening, dye test and polishing of welding roots. Conveyed from X-ray transferring area to X-ray area, the welding lines are tested with X-ray. They are then conveyed to manual argon-arc welding area where welding of flanges and pipe fittings is carried out. Pipes are then conveyed to long pipe dye area where dye test of welding lines is carried out. Pipes are further conveyed to hydraulic pressure test area to carry out hydraulic pressure test. Pipes are then conveyed to the boring area to carry out boring of pipe joints. After passing the inspection of processed product, pipes are conveyed to packaging area to be packaged for delivery. 2). Product delivered as piperows. Qualified long furnace pipes are conveyed by conveying rollers from piperow transferring area to piperow welding area to carry out the welding of piperows. After passing dye test in piperow dye area and hydraulic pressure test in hydraulic pressure test area, piperows are conveyed to shot blast compartment for blasting, and then packaged for delivery.

What we claim is:

1. A production line for manufacturing high temperature alloy furnace pipes and piperows characterized in that it comprises of a casting department production line, a machining department production line and a welding department production line. In the casting production line, a pipeline section is casted into 50-300 mm diameter and 3-6 m length via the process of centrifugal casting. In the machining process, the tectorium of internal bore of the pipeline section is removed via the process of boring hole and a groove is machined via a digitally controlled pipe machine. In the welding process, the pipeline sections are welded into a long pipe via the process of argon-arc welding, and flanges and pipe fitting are welded to make a furnace pipes, and further, long furnace pipes are welded into piperows. Finally, quality products of furnace pipes and piperows are ensured through a series of testing equipments and testing procedures that include a chemical composition test, a mechanical performance test at a room temperature, a mechanical performance test at a high temperature, an air pressure test, a hydraulic pressure test, a fluorescent crack detection, a dye penetrant inspection, a x-ray penetrant inspection, a visual inspection and a dimensional inspection.

2. A production line for manufacturing high temperature alloy furnace pipes and piperows according to claim 1 characterized in that the said casting department production line of the invention arranges a centrifuge in the middle and an intermediate frequency induction furnace at the top right side; the said right side of said intermediate frequency induction furnace is equipped with a heat treatment zone and its bottom left side is equipped with a shaped pipe storage area and its bottom right side is equipped with a sand mold casting area; a pneumatic drawbench car and the pneumatic drawbench car track, leading to a rough pipe storage area above, are equipped above the said centrifuge. Starting from the rough pipe storage area, a rough furnace pipe is conveyed around the centrifuge and counterclockwise in turn by a conveyor roller through a shot blast machine, a rough pipe inspection area, a ready-to-cut area, a pipe cutting area, a fluorescent and gas-tight inspection device area and a fluorescent compartment, and is conveyed to the machining department production line through a safety passage.

3. A production line for manufacturing high temperature alloy furnace pipes and piperows according to claim 1 characterized in that the said machining department production line arranges a boring area of deep hole boring machine of the furnace pipes at the right side divided into two rows up and down, the top right side is equipped with a rough pipe storage area; its left side is also divided into two rows up and down, left of the bottom left side is equipped with a hydraulic pipe section pressure area, right of the bottom left side is equipped with an area for dimensional inspection, roughness inspection and turbulence experiment; its top left side is equipped with an pipe distributing area, cutting area, chambering preparing area, digitally-controlled groove machining area, dimensional inspection and groove dye penetrant area in turn from right to left. Conveyor rollers are arranged among the above processes and convey semi-finished furnace pipes through a safety passage into the welding department production line.

4. A production line for manufacturing high temperature alloy furnace pipes and piperows according to claim 1 characterized in that the said welding department production line of the invention arranges auto-welding area, auto-welding dye penetrant area, manual argon-arc welding area, straightening area, dye area, weld root polishing area and X-ray transferring area in turn from right to left in the first row and arranges X-ray area, manual argon-arc welding area, straightening and long pipe dye area, hydraulic pressure test area, furnace pipe products boring area, processed furnace pipes inspecting and packaging area, and processed products consignment area in turn from left to right in the second row; furnace pipe transferring area is arranged in the packaging and inspecting area for processed furnace pipes; piperow transferring device, piperow welding area, piperow dye area, piperow hydraulic pressure test area are arranged below the said furnace pipe transferring area in turn from right to left in the third row, and piperow shot blasting room, piperow package area, piperow consignment area are arranged in turn from left to right in the fourth row, and conveyor rollers are arranged among the above processes.
